(19) United States
(12) Patent Application Publication
(10) Pub. No.: US 2012/0136941 A1
(43) Pub. Date: May 31, 2012

(54) USER SPECIFIC SHARING FEATURE

(76) Inventors: Timothy Howes, Los Altos, CA (US); Eric Vishria, San Carlos, CA (US)

(21) Appl. No.: 12/957,239

(22) Filed: Nov. 30, 2010

(51) Int. Cl. G06F 15/16

(52) U.S. Cl. 709/206

(57) ABSTRACT

A system for determining sharing options comprises a client with a web browser, an application server, and a content server. The browser tracks the user's browsing activity and transmits user data associated with the user's browsing activity to the application server. The application server analyzes the received user data, determines sharing options for the user based on the analysis, and transmits the determined options to the browser. The browser displays the received sharing options in response to the user indicating a desire to share content with the intended recipients. The system also enables the user to share with intended recipients the content stored on the user's machine. The browser transmits the content from the user's machine to a server accessible by the intended recipients. The system then creates a link for accessing the content stored on the server and transmits the link to the user and/or the intended recipients.

### BACKGROUND

The disclosure generally relates to web browsers, in particular to sharing content through a web browser.

Online users today often share information with each other through electronic mail. If a user finds something interesting on a web page, the user launches an email client, composes an email and copies the content of interest from the web browser to the composed email. Similar steps are performed to share offline content like a file on the user's computer. The user attaches the file as part of the email and sends the email with the attachment to the desired recipients.

While this paradigm is functional, the paradigm in unwieldy and requires users to switch between various applications like the web browser and the email client or between various web sites like the web site with the content and the email website.

Contemporary browsers, browser add-ons and web sites have tried tackling this challenge through providing a share feature. A share feature is provided with pre-configured choices for sharing the information. The choices consist of sharing information through a particular email service or on a particular social networking website. The user therefore is forced to either adapt to the limited sharing options provided by the browser, add-on, or site or stick with the old fashioned way of copying and pasting information into emails.

### SUMMARY

Embodiments of the invention adapt to the user's preferred ways of sharing information. In one embodiment, the users' browsing history is used to determine the user's preferred methods of sharing information. An example of such a method is a feature on a user's social networking site that allows the user to share information with others. When the user wants to share information, the user selects the share feature through a graphical user interface in the browser, and the user is presented with a menu displaying the user's preferred methods of sharing information. After the user selects a particular method of sharing information, the users may be presented with further options specific to the selected method. For example, responsive to the user selecting a sharing feature on the user's social networking site, the user is presented with a list of potential recipients on that site. The user can now select one or more recipients and share the desired information with the selected recipients.

In one embodiment, if the user wants to share offline content located on the user's computer, the user selects and drags the content to a graphical user interface element on the user's browser. The browser then presents a menu including the user's preferred methods of sharing the content. The user then walks through the presented menu and selects a sharing method. Next, the browser uploads the content to an application server and transmits the selected sharing method to the server. The application server stores the received content, creates a link for accessing the content, and transmits the link to the intended recipients' and/or the sharing user's browser. The intended recipients and the sharing user can now access the content by selecting the received link.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1 is a block diagram illustrating a computing environment for sharing content according to one embodiment.

FIG. 2 is a block diagram illustrating a browser according to one embodiment.

FIG. 3 is a block diagram illustrating an application server according to one embodiment.

FIG. 4 is a trace diagram illustrating a method for determining sharing options specific to a user and presenting the determined options according to one embodiment.

FIG. 5 is a trace diagram illustrating a method for sharing offline content according to one embodiment.

### DETAILED DESCRIPTION

The computing environment described herein enables users to share content with other users. The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

### System Environment

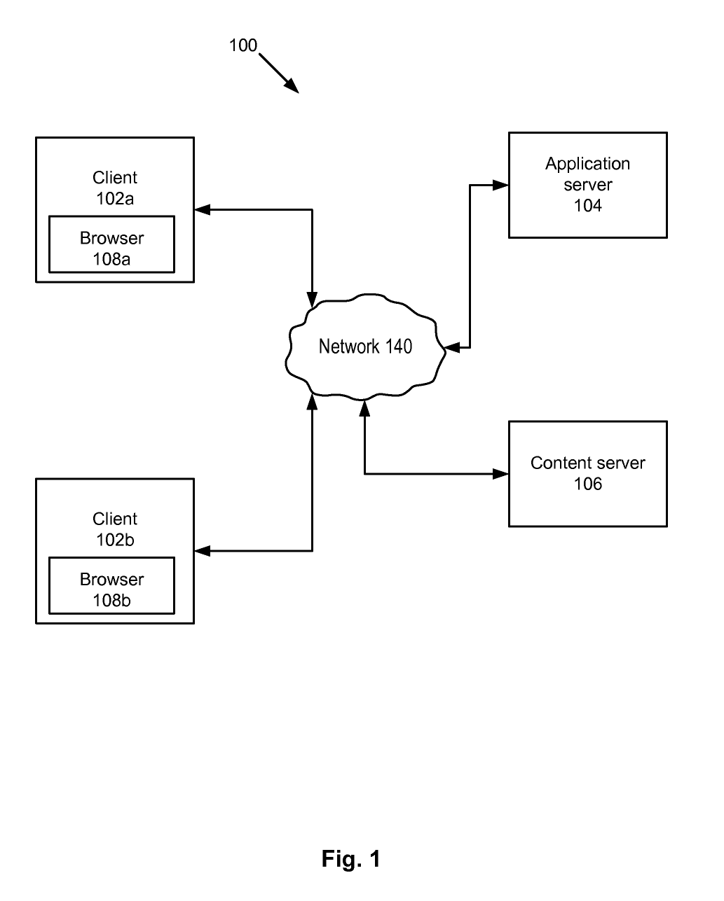

Referring to FIG. 1, the computing environment 100 for sharing content comprises clients 102a-b (collectively referred to as “client 102”) with corresponding browsers 108a-b (collectively referred to as “browser 108”), an application server 104, a content server 106 and a network 140. The client 102 is a computing device with a processor and a memory capable of running applications like browser 108. Examples of client 102 include a desktop, a laptop and a handheld computing device.

The browser 108 is an application for retrieving, presenting, and traversing online data available on various entities like application server 104 and content server 106. Additionally, the browser 108 stores user's browsing activity and transmits the user's browsing activity to the application server 104. The browser 108 also receives from the application server 104 sharing options that are specific to a user and are determined based on the user's browsing activity. The browser 108 displays the received sharing options in response to the user selecting an option to share an object with another user. Additionally, the browser 108 transmits content from the user's client 102 to the application server 104 in response to the user selecting to share the content stored on the user's client 102.

The application server 104 is a computing system with a processor and a memory that receives and stores user data associated with the user's browsing activity. The application server 104 determines sharing options for a user based on the received data and transmits the determined options to the browser 108 for display to the user. Additionally, the application server 104 receives offline content from a user's client 102. The application server 104 stores the received offline content, creates a link, like a URL, associated with the stored content and transmits the created link to the user's or the intended recipient's client 102. The created link can be used to share the stored content with other users.

The content server 106 is a computing device with a processor and a memory that stores online content like web pages, feed content, audio or video streams etc. The content server 106 transmits the stored online content over network 140 upon receiving a request for the stored online content. The content server 106 may host a messaging system such as a social networking system, an email service system, an instant messaging system, a user-generated content system, or any other system that enables two or more users to communicate with each other. In these various embodiments, the content server 106 may support sharing functions for the messaging service that enable a user to share content on the messaging service. For example, the content server 106 supports functions that enable a user to share a URL for a web page, or audio, video or textual content on a page. Additionally, the content server 106 can also supports sub-options for the sharing functions. For example, the content server 106 can support the sub-option for a messaging service that allows the user to shorten the URL being shared with other users.

The network 140 represents the communication pathways between the client 102, the application server 104 and the content server 106. In one embodiment, the network 140 is the Internet. The network 140 can also use dedicated or private communications links that are not necessarily part of the Internet.

### Overview

A user launches a browser 108 on client 102 and provides authentication information to the browser 108. The browser 108 receives user input and authenticates the user. After the user is authenticated, the browser 108 tracks the user's activities on various messaging service sites, such as an email service website, a social networking website, an instant messaging service website, a blogging service website, or any other suitable message service website. The browser 108 stores user data associated with the user activity and transmits the tracked user data to the application server 104. The application server 104 receives the user data and determines sharing options for the user based on the received user data. For example, the application server 104 may receive user data indicating a particular social networking site the user frequently visits. The application server 104 may therefore infer that the user is likely to share information on the frequented site and determines that the site should be presented as one of the sharing options to the user. Accordingly, the application server 104 includes the frequented site as one of the sharing options and transmits the sharing options to the browser 108.

The browser 108 receives the sharing options and displays them to the user at appropriate times. For example, when the user selects an option to share an object like an online article or an image, the browser 108 displays to the user the sharing options previously received from the application server 104. The user may share an object in various ways. For example, the user may right click on a web page and select the sharing option to share a link to the web page. Alternatively, the user may select textual, audio or video content on a page, right click on the selected content, receive a menu, and select the sharing option from the menu. Otherwise, the user may also share content by selecting and dragging the content to a graphical user interface (GUI) element that presents the user with sharing options once an object is dragged on the GUI element or the user selects the GUI element. The user then selects the appropriate sharing option and the browser 108 transmits the selected sharing option to the application server 104. The application server 104 then takes appropriate steps in response to receiving the selected sharing option. Referring back to the above described example, the browser 108 displays the user's frequented social networking site as a sharing option, and the user selects one of the displayed sites for sharing content. The browser 108 then transmits the selected option to the application server 104, the application server 104 determines sub-menu options specific to the selected site and transmits the sub-menu options to the browser 108. The browser 108 then displays the sub-menu options to the user. An example of sub-menu options is a list of users' friends or a privacy setting on the selected social networking site. The user may choose a particular friend as a recipient for the content or a privacy setting for the content from the displayed sub-menu.

Additionally, a user may decide to share online content (e.g., content stored on a server accessible through network 140) or offline content (e.g., content stored on the user's own client 102 or a storage medium attachable to the user's client 102). The online content is already accessible to various users as long as the users have the desired permissions/accounts. To share offline content, the user selects the offline content to be shared through a user interface on browser 108. The browser 108 then transmits the selected content from the user's client 102 to the application server 104. Next, the application server 104 stores the received content and creates a link, like a URL, for the stored content. The created link can now be used by the intended recipients to access the stored content.

The description about the browser 108 and the application server 104 assigns particular functions to one entity or another. This description and the function assignment are for illustration purposes and do not limit the server or the client to their assigned functions. Upon reading this disclosure, one of ordinary skill in the art will understand that functions described in one embodiment as being performed on the server side can also be performed on the client side in other embodiments if appropriate. Similarly, the client side functions can be performed by the server if appropriate. Additionally, the functionality attributed to a particular component can be performed by different or multiple components operating together, as deemed appropriate by the implementer.

Moreover, the browser 108 is described as performing various functions to enable various features for a user. One of ordinary skill in the art will understand that these functions can be implemented in various other applications and these functions are not limited to only a browser 108. For example, the functions described herein can be implemented in a mobile application used to share content among users.

### Browser

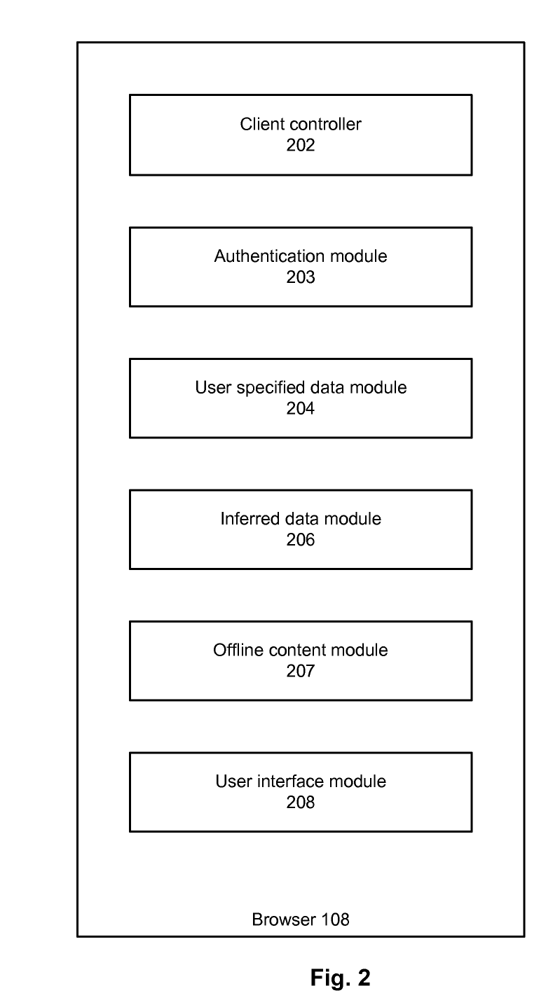

FIG. 2 is a block diagram illustrating the browser 108 according to one embodiment. The browser 108 comprises a client controller 202, an authentication module 203, a user specified data module 204, an inferred data module 206, an offline content module 207 and a user interface module 208.

The client controller 202 directs other modules in browser 108 to implement their respective functions at appropriate time. The client controller 202 also provides an interface between the module in browser 108 and other entities in the computing environment 100.

The authentication module 203 receives the authentication data from the user and authenticates the user. The authentication data comprises user identification and alternatively a corresponding password. The user identification and the password are alpha-numeric strings associated with the user. In one embodiment, the authentication module 203 stores authentication data for one or more users and the authentication module 203 verifies the authentication data received from the user against the stored authentication data. In another embodiment, the authentication module 203 transmits the authentication data to application server 104 or another authenticating entity (not shown) and receives a verification of the authentication data.

After the authentication module 203 authenticates the user, the user specified data module 204 and inferred data module 206 start collecting information about the user's interaction with the browser 108. Because the information is collected after the user's authentication, data modules 204-206 associate the collected information with the user's browsing pattern or browsing activity. In one embodiment, the browser 108 does not include the authentication module 203, the user is not authenticated, and the data modules 204-206 still associate the collected information with the user's browsing pattern or browsing activity. In this embodiment, the data modules 204-206 treat all users of browser 108 as one common user and associate the collected information with that common user's browsing pattern or browsing activity.

The user specified data module 204 receives and stores data that user inputs in the browser 108 or in widgets associated with the browser 108. For example, the user specified data module 204 receives the website addresses the user inputs in the address bar, the search terms the user enters in a search toolbar or a search web page, the login information the user enters in a social networking website or a social networking widget, the information the user enters in forms or shopping orders on a website, or any other information entered by the user in widgets associated with the browser 108 or pages presented by the browser 108. In one embodiment, the user specified data module 204 also stores the frequency with which the user accesses the same web page, searches the same search term, enters the same login information or enters the same information on a web page or a widget. In another embodiment, the user specified data module 204 also tracks and stores the amount of time the user spends on a particular website like a gaming website or a social networking website. The user specified data module 204 repeatedly transmits all or part of its stored information to the application server 104 and the application server 104 uses the received information to determine sharing options for the user.

The inferred data module 206 infers additional data associated with the user based on the user specified data. For example, the inferred data module 206 searches for and stores the embedded links in the web pages accessed by the user. In one embodiment, the inferred data module 206 stores embedded links in an accessed web page only if the embedded link's page rank (e.g., as determined by a search engine) is greater than a threshold. In another embodiment, the web page accessed by the user is the user's homepage on a social networking site. In this embodiment, the inferred data module 206 determines the user's friends through an API provided by the social networking site. The inferred data module 206 then saves the embedded links on the friends' pages as user data. In yet another embodiment, the inferred data module 206 stores the link to the friend's page and/or the friend's identity as user data. The inferred data module 206 repeatedly transmits all or part of its stored information to the application server 104 and the application server 104 uses the received information to determine sharing options for the user.

The offline content module 207 enables a user to share offline content with other users. The offline content module 207 receives from the user the location of the offline content on the user's client 102. The offline content module 207 then transmits the offline content from the user's client 102 to the application server 104. In one embodiment, the offline content 207 also transmits with the offline content an identification string corresponding to the user. The transmitted identification string enables the application server 104 to associate the received content with the user. After the offline content module 207 transmits the offline content, the offline content module 207 receives from the application server 104 a link to the offline content. The received link can be selected by users to access the content that is now stored on the application server 104. The offline content module 207 displays the received link to the user so that the user can share the link with other users. In one embodiment, the user specifies the intended recipients when the user specifies the location of the offline content before the content is uploaded to the application server 104. In this embodiment, the offline content module 207 transmits the received link from the application server 104 to the intended recipients. In yet another embodiment, the offline content module 207 transmits to the application server 104 the received identity of the intended recipients and the application server 104 transmits the link to the intended recipient's clients 102 or to a server accessible by the intended recipients.

The user interface module 208 provides an interface between the user and the messaging services associated with various sharing options. The user interface module 208 receives from the application server 104 the sharing options for the user and displays the sharing options to the user responsive to the user selecting an option to share content with others. In one embodiment, the user interface module 208 also displays additional sharing options that are not specific to any one user.

In one embodiment, the user interface module 208 also receives programming interface or URL associated with various sharing options supported by the messaging services. After the user selects a sharing option, the user interface module 208 invokes a sharing interface or a URL of the messaging service associated with the selected sharing option. The messaging service then provides its own web object or another interface to share the content through the associated messaging service.

In another embodiment, the user interface module 208 receives the sharing option selected by the user and transmits the selected sharing option to the application server 104. The user interface module 208 also receives a sub-menu of options associated with the selected sharing option and displays the received sub-menu options to the user. For example, a user may select a graphical user interface element on the browser 108 to share the link with the user's friends. In response to selection of the interface element, the user interface module 208 displays to the user a number of sites associated with the user. If the user selects to share the link through a particular site, the user interface module 208 receives from the application server 104 a list of features supported by that site. The user interface module 208 displays the received feature list in a sub-menu and the user selects one of the features, like shortening the URL before transmitting it to other users of that particular site.

After the user selects one of the sub-menu options, the user interface module 208 receives the selected sub-menu option and transmits the received option to the application server 104. In one embodiment, the user interface module 208 caches the received sharing options associated with the user and the received sub-menu options associated with each sharing option. The cached sharing and sub-menu options beneficially save bandwidth and time required for fetching the options the next time the user wants to share content with others. To avoid outdated options, the user interface module 208 updates the cached options repeatedly from the application server 104.

Additionally, the user interface module 208 receives from the user the location for offline content to be shared with other users. The user interface module 208 transmits the location to the offline content module 207 and later receives from the application server 104 or the offline content module 207 a link for the uploaded content. The user interface module 208 displays the received link to the user. In one embodiment, the user interface module 208 displays the received sharing options in response to the user selecting to share the offline content. In this embodiment, the offline content is uploaded and/or shared through the messaging service associated by the user.

### Application Server

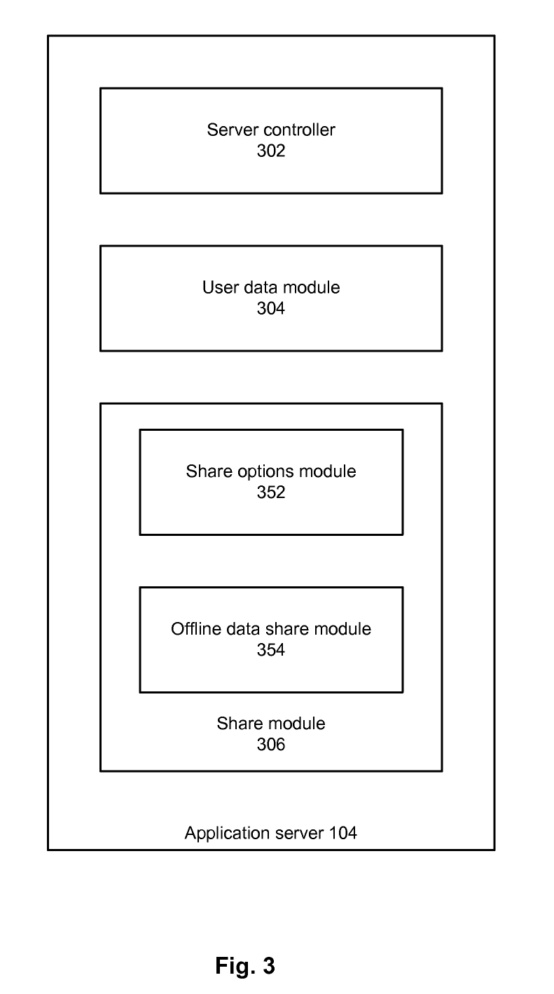

FIG. 3 is a block diagram illustrating the application server according to one embodiment. The application server 104 comprises a server controller 302, a user data module 304 and a share module 306.

The server controller 302 directs other modules in application server 104 to implement their respective functions at appropriate time.

The user data module 304 stores user data associated with users of browser 108. The user data module 304 repeatedly receives user data from the user specified data module 204 and the inferred data module 206. Accordingly, the user data module 304 stores for a user the data directly specified by the user and the data inferred by the browser 108 about the user. Additionally, in one embodiment, the user data module 304 also stores the authentication information for various users. Accordingly, the user data module 304 stores a user login and optionally a password for the user.

The share module 306 communicates with the browser 108 and user data module 304 to provide sharing options and offline data sharing feature to the user of browser 108. The share module 306 comprises a share options module 352 and an offline data share module 354.

The share options module 352 analyzes the user data stored in the user data module 304 and determines the sharing options for a user of browser 108. Accordingly, the share options module 352 analyzes the data explicitly specified by the user and/or the data inferred regarding the user's browsing activity. Based on this analysis, the share options module 352 determines a list of websites associated with the user. The share options module 352 then determines any sharing features associated with the determined websites.

To determine the supported sharing features, the share options module 352 queries a website database (not shown) regarding the sharing features and the corresponding sub-options supported by the determined websites. The website database stores for each website any existing sharing options, sharing sub-options and the corresponding interfaces provided by the websites to enable such sharing. For example, the website database may include an entry for a particular social networking website. The entry includes an option to share an update, and the sub-options to attach a link with the update and to choose the group of intended recipients for the update. Additionally, the entry includes the corresponding interfaces, like function calls, provided by the social networking website to enable the supported options and sub-options.

The website database is populated and updated manually by a database administrator through a user interface. Alternatively, the sharing options module 352 analyzes the user data for new websites visited by the users, polls the newly discovered websites regarding any supported sharing options, and populates the website database with information about the polled websites and their supported features.

The sharing options module 352 may poll the websites for sharing options and sub-options in a variety of ways. For example, the sharing options module 352 may retrieve or receive from the website a file, like a manifest file, that includes information about the sharing function and sharing function sub-options associated with the website. Alternatively, the sharing options module 352 may query the website for pre-determined tags that include information about sharing function and sub-options associated with the sharing function. Regardless of how the sharing options module 352 retrieves the information about sharing function and its sub-options, the sharing options module 352 updates the website database with the retrieved information.

In another embodiment, the sharing options module 352 does not maintain the website database, and instead it polls the websites for their supported sharing options whenever new sharing options need to be determined for a user.

An example below further describes the functioning of share options module 352. In this example, the share options module 352 determines from the explicitly specified data that the user logs into a first social networking site and therefore the user is a member of that social networking site. Additionally, the share options module 352 determines from the inferred data that the user frequents a second website and a third website. Accordingly, the share options module 352 determines that the user is likely to share data on the first social networking web site, the second website and the third website.

Next, the share options module 352 determines if the three websites allow a user to share data with other users and any existing sharing options supported by the three websites. The share options module 352 queries the database or polls the three websites to determine any sharing options supported by the websites. The share options module 352 then determines that the first website does not support any sharing options, the second website does support a basic sharing option but does not support any sub-options, and the third website (www.linkedin.com) supports both options and sub-options. The share options module 352 then determines the options for the second website and the third website.

After determining the sharing options for various websites associated with the user, the share options module 352 transmits the determined sharing options to the user's browser 108. In one embodiment, the share options module 352 caches the sharing options for a use for later transmission to the user's browser 108. Accordingly, the share options module 352 stores a user's identification, the associated websites and the sharing options for those websites. The share options module 352 later re-transmits the sharing options to the user's browser 108 in response to receiving a request for the sharing options. Additionally, the share options module 352 repeatedly updates the associated websites and their sharing options for the user. The caching and updating of a user's sharing options beneficially allows the share options module 352 to transmit the options without spending time and processing power in determining the options when the browser 108 requests this information again for the user.

As discussed above, the share options module 352 determines and transmits sharing options for a user based on the user's browsing activity. Accordingly, the sharing options provided to the user are not standard options determined by a browser for all the users. Instead, the sharing options are beneficially tailor-made or specific to the user's browser activity. Additionally, the sharing options module also beneficially provides sub-options that are specific to a chosen sharing method. Moreover, the user need not navigate multiple web-pages for sharing content with other users. The share options module 352 beneficially reduces the number of web-pages navigated by the user to share content with other user. In one embodiment, the share options module 352 beneficially allows the user to select the content to be shared, the sharing options for the selected content, and the sub-options corresponding to the selected option without leaving the website. The share options module 352 therefore enhances the user's sharing experience by providing user-specific sharing options and site-specific sub-options through a reduced number of navigated pages. The user's sharing experience is further enhanced by the offline content sharing feature partly supported by the offline data share module 354.

The offline data share module 354 enables a user to create a link to content stored on the user's client 102 and share the link with other users. The other users can then access the content through the shared link. The offline data share module 354 receives the offline content from browser 108 on the user's client 108. The offline data share module 354 stores the received offline content and creates a link for the stored offline content. Next, the offline data share module 354 transmits the link to the browser 108 on the user's client 102, the browser 108 on the intended recipient's client 108, or an intermediary web server that hosts the link for the user and the intended recipient's access. An example of such an intermediary server is the web server of messaging service associated with the sharing option selected to share the offline content.

### Sharing Options Determination Methodology

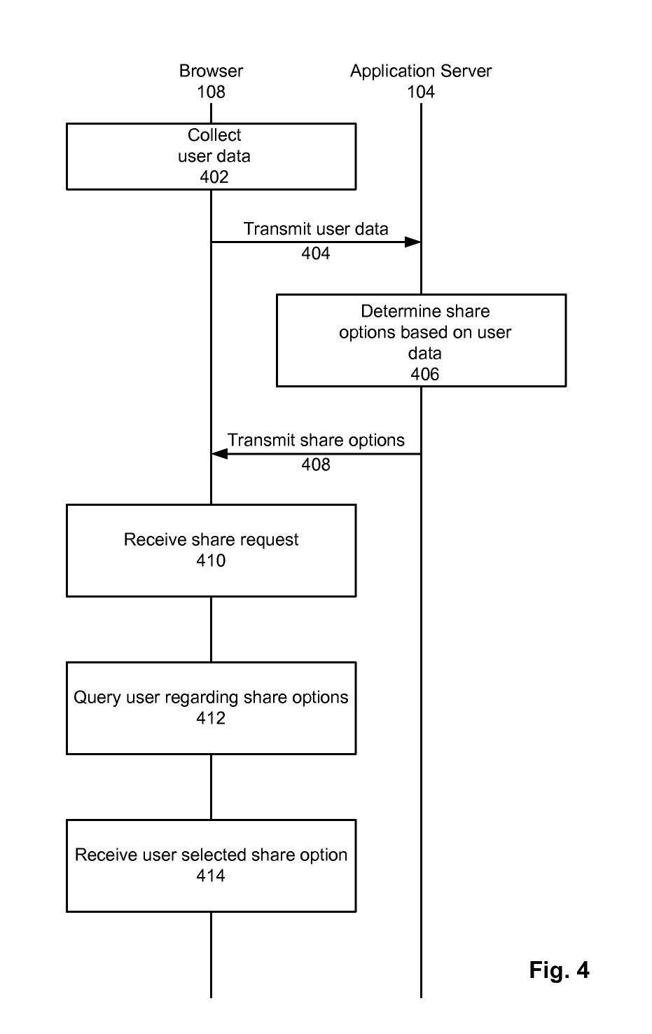

FIG. 4 is a trace diagram illustrating a method for determining sharing options specific to a user and presenting the determined options according to one embodiment. The method begins with the browser 108 monitoring user browsing activity and collecting 402 user data. The browser 108 then transmits 404 the collected user data to the application server 104. The steps of collecting 402 and transmitting 404 user data are performed repeatedly to keep the user data updated on the application server 104. The application server 104 receives the user data and determines 406 the share options for a user based on the received user data. The application server 104 then transmits 408 the determined share options to the browser 108. In addition to the share options, the application server 104 may also determine and transmit sub-menu options specific to a particular share option.

At some point during the user's browsing experience, the user decides to share content with other users and the user selects a graphical user interface element displayed on browser 108 indicating the user's intent. The browser 108 receives the user's request to share content and the browser 108 queries the user with the sharing options previously received from the application server 104. In one embodiment, one or more of the steps of determining 406 and transmitting 408 the user's sharing options are not performed before the browser 108 receives 410 the user's request to share content. Instead, the browser 108 requests the application server 104 for the sharing options and the application server 104 performs the determining 406 or transmitting 408 step in response to the request.

Regardless of the order of steps 406-410, the browser 108 receives a selected 414 sharing option from the user and the browser 108 takes appropriate steps based on the received selection. If the selection option is associated with sub-menu options, the browser 108 displays the sub-menu options to the user. Alternatively, the browser 108 may call an interface on a website associated with the sharing option in response to the user's selection.

### Sharing Offline Content Methodology

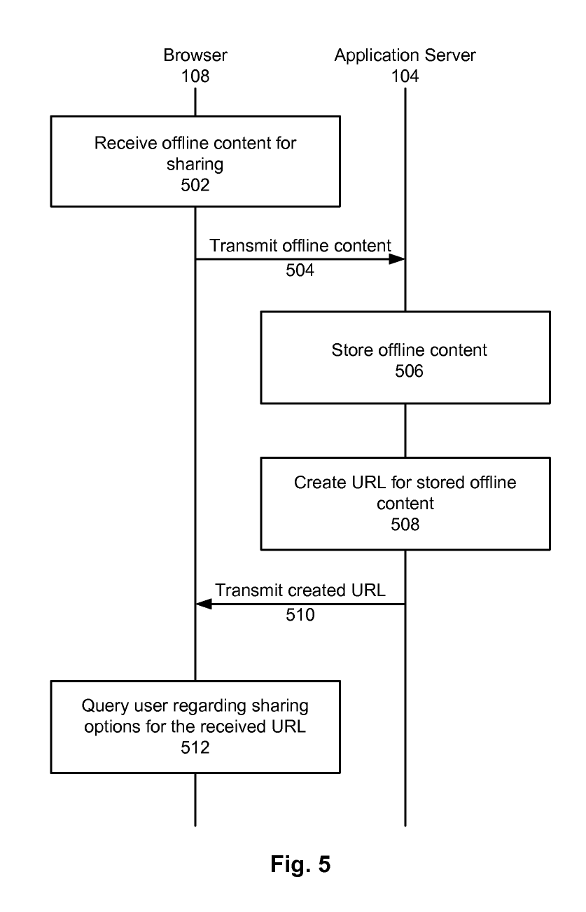

FIG. 5 is a trace diagram illustrating a method for sharing offline content according to one embodiment. The user selects an option to share offline content through a graphical user interface (not shown) on the browser 108. The user then specifies the location of the offline content on the user's client 102 and the browser 108 receives 502 the location of the offline content. In one embodiment, the user specifies the location of the offline content by dragging an icon representing the offline content on the offline sharing graphical user interface of the browser 108. The icon is associated with the content's location and the browser 108 determines the location of the content through the received icon. The browser 108 then transmits 504 the offline content from the received location to the application server 104. The application server 104 receives the offline content, stores 506 the offline content, creates 508 a URL for the stored content, and transmits 508 the created URL to the browser 108. The browser 108 then displays the URL to the user and queries the user regarding sharing the displayed URL with other users.

The user may select the content's intended recipients through various methods. In one embodiment, the user provides to the browser 108 the contact information for the intended recipients with the location of the offline content. Examples of contact information include an e-mail address, a webpage address, a phone number, and identification on a messaging service like Yahoo Messenger. The browser 108 then transmits to the application server 104 the intended recipient's contact information. After the application server 104 determines the URL for the content, the application server 104 directly transmits the URL to the intended recipient instead of transmitting it to the user. The application server 104 may transmit the URL to the user as well but the user does not need to forward the URL to the previously selected intended recipients. The application server 104 performs the additional step for the user. In another embodiment, the user provides an identification for the intended recipient and the browser 108 or the application server 104 determines the contact information corresponding to the intended recipient's identification. The browser 108 or the application server 104 may query a database or a website that stores the contact information associated with the intended recipient.

Alternatively, responsive to the user selecting an option to share offline content, the browser 108 displays the sharing options that are based on the user's browsing activity. The user then selects a sharing option and specifies the messaging service to share the offline content with others. The application server 104 receives the offline content from the browser 108 and transmits to the selected messaging service the link to the received content. In another embodiment, the offline content is directly uploaded to the messaging service's server and the messaging service forwards to the intended recipients the content or a link to the content

In this manner, the browser 108 and the application server 104 beneficially provide a method to share offline content with other users throughout various networks. The user need not be limited to sharing the content only with users that have email accounts or with members of a particular social network. The user can beneficially use the browser 108 to share offline content with any user whose client can display a link like a URL.

As mentioned above, the functionality of the browser 108 and the application server 104 has been described for illustration purposes and the above described functionality can be implemented either in the browser 108 or the application server 104. For example, the application server 104 is illustrated above as including the user data module 304 and the share module 306. In one embodiment, these modules 304-306 are included in the browser 108. Accordingly, the authentication module 203 authenticates the user, the data modules 204-206 collect information about the user's browsing history or browsing pattern and transmit the collected information to the user data module 304 in browser 108. The share module 306 in browser 108 analyzes the user data in user data module 304, determines the share options for the user, and displays the sharing options to the user through the user interface module 208.

Referring to another example, the relevant functionality of both the browser 108 and the application server 104 may be implemented by a web server associated with a website. Accordingly, the web server tracks the user's browsing activity, determines the user's preferred method of sharing content and presents the user with the determined methods as options to share offline or online content.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer program product for sharing content, the computer program product comprising a computer-readable storage medium containing computer program code for:
receiving information about a user's interaction with a messaging service, the messaging service enabling users to send messages to each other;
storing the information about the user's interaction with the messaging service;
receiving user's request to share content;
determining the messaging service as a potential service for the user to share content, the determination based on the stored information about the user's interaction with the messaging service; and
initiating a user interface including a sharing option corresponding to the determined messaging service for communication to the user.

2. The computer program product of claim 1, wherein the computer program product is stored at the messaging service.

3. The computer program product of claim 1, further comprising computer program code for:
receiving a user selection of the messaging service; and
transmitting, to the selected messaging service, the user's request to share content.

4. The computer program product of claim 1, wherein the sharing option corresponds to a sharing feature of the messaging service, further comprising computer program code for:
determining a sub menu associated with the sharing option, the sub menu including options associated with the sharing feature; and
transmitting the determined sub menu to the user's computer.

5. The computer program product of claim 1, wherein the messaging service is a social networking website.

6. The computer program product of claim 1, wherein the messaging service is a blogging website.

7. The computer program product of claim 5, wherein the option associated with the sharing feature is a privacy setting.

8. The computer program product of claim 6, wherein the option associated with the sharing feature is an option to shorten a URL associated with the content being shared.

9. The computer program product of claim 4, wherein the sharing option and the associated sub menu options are cached for later transmission to the user's computer or another user's computer.

10. A computer-implemented method for sharing content, the method comprising:
receiving information about the user's interaction with a messaging service, the messaging service enabling users to send messages to each other;
storing the information about the user's interaction with the messaging service;
receiving user's request to share content;
determining the messaging service as a potential service for the user to share content, the determination based on the stored information about the user's interaction with the messaging service; and
initiating a user interface including a sharing option corresponding to the determined messaging service for communication to the user.

11. The computer program product of claim 10, wherein the user interface is initiated by the messaging service.

12. The computer implemented method of claim 10, wherein the sharing option corresponds to a sharing feature of the messaging service, the method further comprising:
determining a sub menu associated with the sharing option, the sub menu including options associated with the sharing feature; and
transmitting the determined sub menu to the user's computer.

13. A computer implemented method of sharing content, the method comprising:
receiving, from a user's computer, content selected by the user for sharing with an intended recipient;
storing the received content in a storage;
creating a link to the stored content, the link providing access to the stored content;
transmitting the link providing access to the stored content;
receiving a request from a computer of the intended recipient for the stored content responsive to selection of the transmitted link; and
transmitting the stored content to the intended recipient's computer.

14. The computer implemented method of claim 13, wherein the transmitted link is first transmitted to the user's computer and then forwarded to the intended recipient's computer.

15. The computer implemented method of claim 13, wherein the link to be later selected by the intended recipient is transmitted to the intended recipient's computer.

16. The computer implemented method of claim 13, further comprising:
receiving information from the user's computer about the user's interaction with a messaging service, the messaging service enabling users to send messages to each other;
storing the information about the user's interaction with the messaging service;
determining the messaging service as a potential service for the user to share content, the determination based on the stored information about the user's interaction with the messaging service; and
transmitting a sharing option corresponding to the determined messaging service for communication to the user, wherein selection of the sharing option results in receiving content selected by the user for sharing with the intended recipient.

17. The computer implemented method of claim 16, wherein the sharing option corresponds to a sharing feature of the messaging service, the method further comprising:
determining a sub menu associated with the sharing option, the sub menu including options associated with the sharing feature;
transmitting the determined sub menu to the user's computer; and
receiving a selected sub menu option in response to the user's selection of an option associated with the sharing feature.

18. The computer implemented method of claim 16, wherein the messaging service is a social networking website.

19. The computer implemented method of claim 16, wherein the messaging service is a blogging website.

20. The computer implemented method of claim 18, wherein the option associated with the sharing feature is a privacy setting.

21. The computer implemented method of claim 19, wherein the option associated with the sharing feature is an option to shorten a URL associated with the content being shared.

22. The computer implemented method of claim 17, wherein the sharing option and the associated sub menu options are cached for later transmission to the user's computer or another user's computer.
